(19) United States
(12) Patent Application Publication
(10) Pub. No.: US 2011/0044576 A1
(43) Pub. Date: Feb. 24, 2011

(54) FIBRE OPTIC SENSOR

(76) Inventor: Barry Colin Crane, Oxfordshire (GB)

Correspondence Address: FISH & RICHARDSON P.C. (TC), PO BOX 1022, MINNEAPOLIS, MN, 55440-1022, US

(21) Appl. No.: 12/918,038

(22) PCT Filed: Feb. 20, 2009
(86) PCT No.: PCT/GB09/00502

§ 371 Date: Nov. 15, 2010

(30) Foreign Application Priority Data
Feb. 26, 2008 (GB) 0803492.8

(51) Int. Cl. G02B 6/00; B29D 11/00

(52) U.S. Cl. 385/12; 264/1.1; 264/1.37

(57) ABSTRACT

A fibre optic sensor for detecting or measuring the concentration of an analyte in a medium, the sensor having a sensing region (1) for insertion into the medium during use, which sensing region comprises a cell containing an indicator for the analyte, wherein the cell comprises a central portion (CE) arranged longitudinally within the fibre and one or more crossing portions (CR1, CR2, CR3) which intersect the central portion.

The present invention relates to a fibre optic sensor and a method for making a fibre optic sensor.

### BACKGROUND TO THE INVENTION

Optical fibres have in recent years found use as chemical or biological sensors, in particular in the field of invasive or implantable sensor devices. Such optical fibre sensors typically involve an indicator, whose optical properties are altered in the presence of the analyte of interest. For example, fluorophores having a receptor capable of binding to the target analyte have been used as indicators in such sensors.

Optical fibres can operate by passing incident light along the fibre and through one or more optical cells containing the indicator. In the case of an indicator containing a fluorophore, the incident light excites the fluorophore and causes emission of light of a different wavelength. The concentration of the analyte can be determined by measuring a property, typically the intensity, of the emitted fluorescent light (the signal).

The intensity of the emitted light, however, is dependent not only on the concentration of the analyte, but also on the path length of cell containing the indicator and the intensity of incident light passing through the cell. In order to maximise the signal, these factors also need to be taken into account. In one earlier patent, U.S. Pat. No. 4,889,407, the inventors aim to maximise the amount of incident light which passes through an indicator-containing cell by providing the indicator in a helical array of cells. The cells are designed to substantially cover the cross-sectional area of the fibre to ensure that incident light is not lost.

This prior art design has a number of disadvantages, however. In particular, the incident light must pass through a number of interfaces between materials of different refractive index before reaching the distal end of the fibre. At each interface, scattering occurs leading to a loss of light and a reduced intensity of signal.

An alternative proposal is simply to locate a cell containing the indicator within the distal end of the fibre. However, there are mechanical limits on the size of cell which can be generated by the usual technique of laser ablation into the end of the fibre, due to the inherent tapering of a laser ablated hole. This limitation on the path length of the cell leads to an inherent limitation on the intensity of the emitted signal which can be achieved.

It is therefore an object of the invention to provide an improved fibre optic sensor in which the intensity of the signal can be improved.

### SUMMARY OF THE INVENTION

The present invention provides a fibre optic sensor for detecting or measuring the concentration of an analyte in a medium, the sensor having a sensing region for insertion into the medium during use, which sensing region comprises a cell containing an indicator for the analyte, wherein the cell comprises a central portion arranged longitudinally within the fibre and one or more crossing portions which intersect the central portion.

The cell of the present invention thus comprises a central portion which is longitudinally arranged, typically within the centre of the fibre. The intensity of incident light which is passed along the fibre is generally at its highest in the centre of the fibre. Locating the indicator in a central cell therefore maximises the intensity of incident light which reaches the indicator.

The cell is typically manufactured by laser ablating one or more holes extending across the fibre (e.g. radially across the fibre) to form the crossing portions, and subsequently laser ablating a hole extending longitudinally through the fibre, and intersecting with the crossing portions, to form the central portion. The initial formation of the crossing portions significantly facilitates the later formation of the central portion, since the material at each intersection point has already been ablated. In this way, a longer central portion, extending further into the fibre from its distal end, can be generated than is possible in the absence of the crossing portions. The cell therefore has a long path length, located centrally within the fibre where the intensity of incident light is at its maximum. In this way, the intensity of any emitted signal is maximised.

The sensor of the invention has further advantages over the design of U.S. Pat. No. 4,889,407 since the indicator is generally provided within a single cell. This reduces the number of times the incident light must cross an interface between materials of different refractive index, and thereby reduces scattering of the incident light beam.

The present invention also provides a method of producing a fibre optic sensor of the invention, which method comprises providing a cell by (a) forming one or more holes extending across the sensing region of the fibre to provide one or more crossing portions; and then (b) forming a hole through the distal end of the fibre and extending longitudinally within the sensing region of the fibre to provide a central portion, such that the central portion intersects the one or more crossing portions, and providing an indicator to the cell. The holes are typically produced by laser ablation.

Also provided is a method of detecting or measuring the concentration of an analyte in a medium, which method comprises inserting the sensing region of a fibre optic sensor according to the invention into the medium, passing incident light along the fibre and measuring an emitted signal.

### BRIEF DESCRIPTION OF THE FIGURES

FIGS. 1a and 1b are schematic depictions of the sensing region of fibre optic sensors of the invention.

FIG. 2 is a cross section of the sensing region of a fibre optic sensor of the invention.

### DETAILED DESCRIPTION OF THE INVENTION

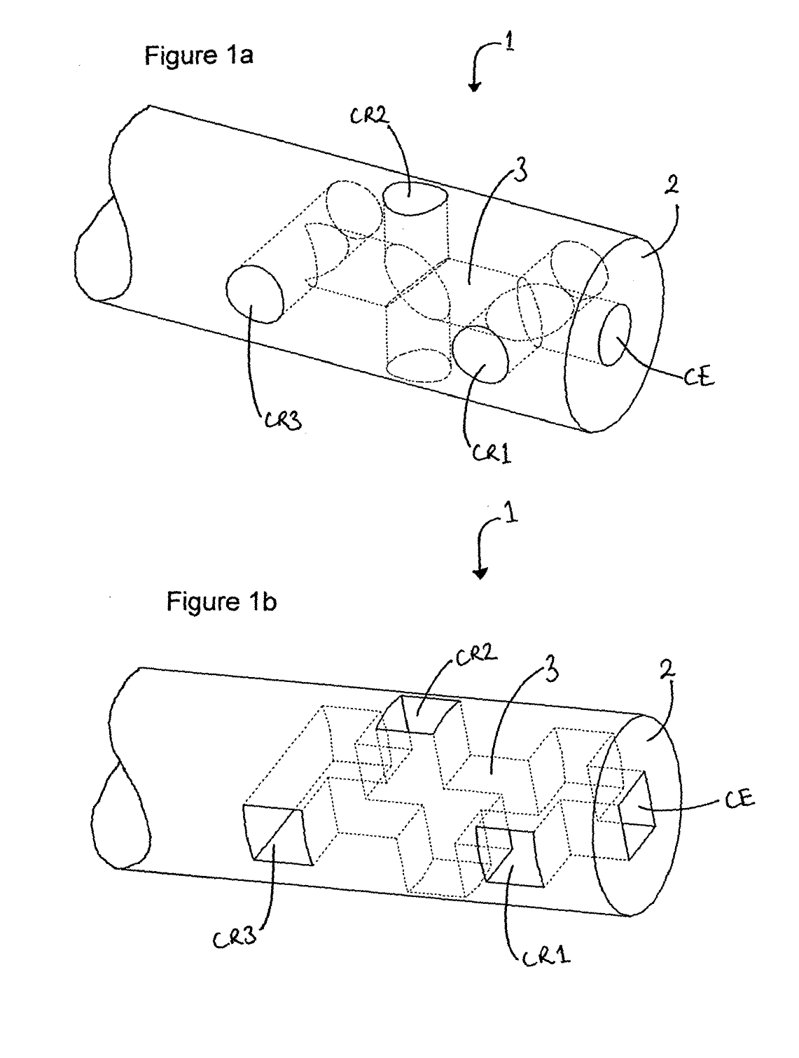

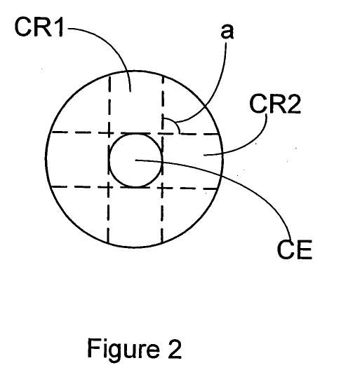

FIG. 1a schematically depicts the sensing region 1 of a fibre optic sensor of the invention and FIG. 2 provides an alternative view of the same sensor through a cross section of the sensing region. The sensing region is typically located at or near to the distal end, or tip, 2 of the fibre. During use, the sensing region is the part of the fibre which is in contact with the medium under study.

The sensing region comprises a cell (CE, CR1, CR2, CR3) which typically contains an indicator for the analyte. The indicator may be any material whose optical properties are altered in the presence of the analyte. Preferred indicators are those containing a fluorophore, although other indicators suitable for use in optical fibres are also envisaged, for example other luminescent indicators or absorbent indicators. Examples of suitable indicators are pH sensitive indicators, potassium indicators such as crown ethers, and indicators containing a boronic acid group and a fluorophore which are sensitive to glucose or other saccharides.

The cell comprises a central portion CE which extends longitudinally within the fibre. As depicted in FIGS. 1a, 1b and 2, the central portion CE is typically located within the central part of the fibre. This means that indicator contained within the central portion will be exposed to a maximum intensity of incident light, since the incident light is at its highest intensity in the middle of the fibre.

The length of the central portion is desirably as long as is practically possible in order to maximise the path length of the cell. Preferably, the central portion has a length of at least 0.3 mm, preferably at least 0.4 mm, 0.5 mm, 0.6 mm or at least 0.7 mm. The length will generally be limited by the practicalities of generating a hole through the length of the fibre. As discussed above, the presence of the crossing portions facilitates the generation of the hole for the central portion and enables a longer cell to be produced. The central portion is likely to have a length of up to about 1.5 mm, e.g. up to about 1 mm.

The diameter of the central portion (or maximum width in the case of non-cylindrical central portions) is limited only by the width of the fibre and the need to maintain sufficient mechanical strength in the fibre. A suitable diameter of the central portion for a 250 μm fibre is in the region of 80 μm, for example from 60 to 100 μm. The skilled person would be able to determine suitable sizes for the central portion in the case of fibres of different sizes.

The cell additionally comprises crossing portions CR1, CR2 and CR3. As here depicted, three crossing portions are present. However, there may be as few as one crossing portion or, if desired, as many as 5 or 10 crossing portions. There is no particular maximum on the number of crossing portions which is provided. However, to reduce manufacturing costs, it is generally desired to use no more than 4 crossing portions, for example 2 or 3 crossing portions.

The central portion of the cell is arranged longitudinally within the fibre. The crossing portions are arranged so that they intersect the central portion, and are typically (although not essentially) positioned radially within the fibre. In order to maximise the mechanical strength of the fibre, the crossing portions are preferably arranged so that adjacent crossing portions are not parallel to one another. As depicted in FIG. 2, when viewed along a cross section of the fibre, the angle (a) between the crossing portions is generally at least 20°, preferably at least 45°, for example at least 60°, or at least 80°. In a preferred embodiment, maximum mechanical strength is achieved by locating the crossing portions substantially perpendicular to adjacent crossing portions.

The diameter of the crossing portions (or maximum width in the case of non-cylindrical crossing portions) is not particularly limited. A suitable diameter of each crossing portion for a 250 μm fibre is in the region of 80 μm, for example from 60 to 100 μm. The skilled person would be able to determine suitable sizes for the crossing portions in the case of fibres of different sizes.

The shape of the central and crossing portions of the cell is not particularly limited. These portions are generally formed by laser ablation, so a range of different shapes may be achieved. In one embodiment, the central and crossing portions are cylindrical in shape, as depicted in FIG. 1a. This reduces the number of corners in the cell which can serve as weak points leading to cracking of the fibre material. In an alternative embodiment depicted in FIG. 1b, the central and crossing portions have a square cross section. This ensures that any internal faces of the cell are flat and will not reflect light passing along the fibre. A further embodiment might employ portions having a cross section which is substantially square or rectangular, but having rounded corners. Such an embodiment has no sharp corners to serve as weak points, but also has the advantage of having substantially flat internal faces.

In order to enable the sensor to function, the analyte being tested must be able to enter the cell containing the indicator. The central portion and/or one or more of the crossing portions therefore extend to the edge of the fibre to enable analyte to enter the cell. Typically, at least one or more of the crossing portions will extend to the edge of the fibre. As depicted in FIGS. 1a, 1b and 2, the crossing portions may extend to the edge of the fibre at both ends. It is generally advantageous to enable analyte to enter the cell as easily as possible. In a preferred embodiment, therefore, each crossing portion is formed by generating a hole though the entire width of the fibre, so that analyte can enter the cell from either end of each crossing portion.

The central portion may also extend to the distal end of the fibre 2, providing a further entry point for analyte into the cell. However, in some embodiments it may be desirable to cap the distal end of the cell, for example with a reflective cap.

It is desirable to arrange the crossing portions as close together as possible. Analyte will typically enter the cell through the crossing portions, and possibly also through the distal end of the central portion. Parts of the central portion which lie between the crossing portions (3 of FIGS. 1a and 1b) may therefore have a longer diffusion pathway for the analyte than the crossing portions themselves. The increased diffusion pathway causes the response time of the sensor to be increased. It is therefore preferable to minimise the analyte diffusion pathway as much as possible. Arranging the crossing portions close together minimises the volume of these parts 3, and also facilitates diffusion of the analyte into these parts. In a preferred embodiment, therefore, adjacent crossing portions are separated by no more than 150 μm, for example no more than 100 μm. To maintain the mechanical strength of the fibre, it is generally preferred that the crossing portions are separated by at least 30 μm, for example at least 50 μm or at least 60 μm. The distance between adjacent crossing portions is taken as the distance at the intersection with the central portion.

The cell of the invention is typically formed by laser ablation using a suitable high frequency laser such as a YAG laser or excimer laser. Alternative means of generating the holes may also be used, for example mechanical means such as punching or drilling. The cell is produced by first generating the holes for the crossing portions. These typically pass through the entire width of the fibre, although crossing portions which do not pass through the entire width of the fibre are also envisaged.

Subsequent to the formation of the crossing portions, the central portion is formed, typically by laser ablation through the distal end of the fibre, such that each crossing portion is intersected by the central portion. Since some material in the central part of the fibre has already been removed by the formation of the crossing portions, laser ablation of the central portion is facilitated. Laser ablation of the central portion is, for example, carried out as follows:
(i) a first laser pulse (or series of pulses) ablates material between the distal end 2 of the fibre and the first crossing portion CR1;
(ii) a second laser pulse (or series of pulses) ablates material between the first and second crossing portions CR1 and CR2; and so on.

In this way, each laser pulse (or series of pulses) must remove only a small amount of material and tapering of the hole produced is limited. A central portion having increased length is thus provided.

Subsequent to the formation of the cell, an indicator is inserted into the cell. This step may be achieved by any appropriate technique that results in the indicator being immobilised within the cell. In a typical embodiment, a mixture comprising the indicator and a hydrogel-forming monomer is inserted into the cell. The hydrogel-forming monomer is then polymerised, generating within the cell a hydrogel having the indicator entrapped therein.

A hydrogel-forming monomer is a hydrophilic material, which on polymerisation will provide a hydrogel (i.e. a highly hydrophilic polymer capable of absorbing large amounts of water). Examples of hydrogel-forming monomers include acrylates having hydrophilic groups such as hydroxyl groups (e.g. hydroxy ethyl methacrylate (HEMA)), acrylamide, vinylacetate, N-vinylpyrrolidone and similar materials. Hydrogels made from such materials are well known in the biological field, for example for use in sensors. Alternative or additional monomers may be combined with the hydrogel-forming monomer if desired, for example ethylene glycol methacrylate, or polyethylene glycol methacrylate. Cross-linking agents such as the diacrylates and dimethacrylates may also be used.

The polymerisation reaction may be initiated by any suitable means such as by heating or applying UV light, typically in the presence of a polymerisation initiator. UV light is preferred as it is typically less damaging to the materials involved. Suitable initiators will be well known in the art. Examples of photoinitiators where UV light is used include Irgacure® 651 (2,2-dimethoxy-1,2-diphenylethan-1-one) and Irgacure® 819 (bis acyl phosphine) (Ciba-Geigy). Examples of thermal initiators include AIPD (2,2′-azobis[2-([2-(2-imidazolin-2-yl)propane]dihydrochloride) and AIBN (2,2′-azobis(2-methylpropionitrile)).

In a first embodiment, the indicator is physically entrapped within the hydrogel. This is achieved simply by mixing the indicator with the hydrogel-forming monomer prior to initiation of polymerisation. Alternatively, the initiator may be chemically bound to the hydrogel. This latter embodiment has the advantage that reduced leakage of the indicator out of the hydrogel structure occurs. Chemical bonding of the indicator to the hydrogel may be achieved by modifying the indicator as necessary so that it includes a group which will take part in the polymerisation reaction. Typically, an indicator will be modified to include a C═C double bond. Polymerisation of the mixture of modified-indicator and hydrogel-forming monomer thus generates a polymer which includes within its structure units derived from the indicator as well as hydrogel.

An example of the modification of an indicator to include a polymerisable group is provided by Wang (Wang, B., Wang, W., Gao, S., (2001). Bioorganic Chemistry, 29, 308-320). This article describes the synthesis of a monoboronic acid glucose receptor linked to an anthracene fluorophore that has been derivatised with a methacrylate group.

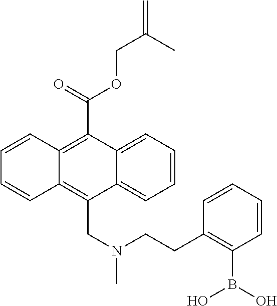

The skilled person in the art would be able to carry out modifications to alternative indicators using analogous methods or other techniques known in the art.

The present invention has been described with respect to specific embodiments, but it is to be understood that the invention is not intended to be limited to these specific embodiments.

1. A fibre optic sensor for detecting or measuring the concentration of an analyte in a medium, the sensor having a sensing region for insertion into the medium during use, which sensing region comprises a cell containing an indicator for the analyte,
wherein the cell comprises a central portion arranged longitudinally within the fibre and one or more crossing portions which intersect the central portion.

2. A sensor according to claim 1, having two or three crossing portions intersecting the central portion.

3. A sensor according to claim 1, wherein at least one crossing portion extends to the edge of the fibre to enable analyte in the medium to enter the cell during use.

4. A sensor according to claim 1, wherein each crossing portion, when viewed along a cross section of the fibre, is positioned at an angle of at least 60° to any adjacent crossing portion.

5. A sensor according to claim 1, wherein adjacent crossing portions are separated by a distance of from 30 to 100 μm, said distance being measured from the point of intersection of each crossing portion with the central portion.

6. (canceled)

7. A method of producing a fibre optic sensor for detecting or measuring the concentration of an analyte in a medium, the sensor having a sensing region for insertion into the medium during use, which sensing region comprises a cell containing an indicator for the analyte,
wherein the cell comprises a central portion arranged longitudinally within the fibre and one or more crossing portions which intersect the central portion,
which method comprises providing a cell by (a) forming one or more holes extending across the sensing region of the fibre to provide one or more crossing portions; and then (b) forming a hole through the distal end of the fibre and extending longitudinally within the sensing region of the fibre to provide a central portion, such that the central portion intersects the one or more crossing portions, and providing an indicator to the cell.

8. A method according to claim 7, which further comprises capping one or more of the thus formed holes.

9. A method according to claim 7, wherein the holes are produced by laser ablation.

10. A method of detecting or measuring the concentration of an analyte in a medium, which method comprises inserting the sensing region of a fibre optic sensor into the medium, passing incident light along the fibre and measuring an emitted signal, wherein the fibre optic sensor is for detecting or measuring the concentration of an analyte in a medium, the sensor having a sensing region for insertion into the medium during use, which sensing region comprises a cell containing an indicator for the analyte,
wherein the cell comprises a central portion arranged longitudinally within the fibre and one or more crossing portions which intersect the central portion.
